(19) United States
(12) Patent Application Publication
(10) Pub. No.: US 2025/0225961 A1
(43) Pub. Date: Jul. 10, 2025

(54) DEVICE AND METHOD FOR INTONATION DETECTION AND TUNING OF MUSICAL INSTRUMENTS

(71) Applicant: Chenchao Hong, Zhejiang (CN)

(72) Inventors: Chenchao Hong, Zhejiang (CN); Wentao Miao, Zhejiang (CN); Shenhong Shao, Zhejiang (CN); Jia Zhang, Zhejiang (CN); Junhuo Hong, Zhejiang (CN); Hong Miao, Zhejiang (CN)

(73) Assignee: Chenchao Hong, Zhejiang (CN)

(21) Appl. No.: 18/622,035

(22) Filed: Mar. 29, 2024

(30) Foreign Application Priority Data
Jan. 4, 2024 (CN) 202410015683.1

(51) Int. Cl. G10D 3/14

(52) U.S. Cl. CPC G10D 3/14

(57) ABSTRACT

Provided is a device and method for intonation detection and tuning of musical instruments. The device includes a vibration signal acquisition module, an audio signal acquisition module, a vibration signal processing module, an audio signal processing module and a display module connected with a control module, the vibration signal acquisition module is configured to acquire vibration signals, the vibration signal processing module is configured to perform intonation comparison according to the acquired vibration signals and pre-stored standard vibration signals, the audio signal acquisition module is configured to acquire audio signals, and the audio signal processing module is configured to process the audio signals, perform intonation comparison according to the processed signals and pre-stored standard audio signals, and display comparison results through data and waveforms. The provided device and method can detect musical instrument intonations based on vibration signals and audio signals, thereby reducing professional and experience requirements for tuner.

### CROSS-REFERENCE TO RELATED APPLICATION

This patent application claims the benefit and priority of Chinese Patent Application No. 202410015683.1 filed with the China National Intellectual Property Administration on Jan. 4, 2024, the disclosure of which is incorporated by reference herein in its entirety as part of the present application.

### TECHNICAL FIELD

The present disclosure relates to the technical field of tuning musical instruments, in particular to a device and method for intonation detection and tuning of musical instruments.

### BACKGROUND

With the development of electronic musical instruments and the pursuit of music culture and individuality, customized musical instruments will become a new trend in the market. Musical instrument repair professionals need to master more flexible design, precise manufacturing and professional maintenance technology by analyzing a large amount of data accumulation, so as to meet the individual needs of customers. In addition, a high-level and high-precision method for intonation detection and tuning of musical instruments is also needed to support the tuning requirements of customized musical instruments. Therefore, it is very necessary to design a device and method for intonation detection and tuning of musical instruments.

### SUMMARY

The purpose of the present disclosure is to provide a device and method for intonation detection and tuning of musical instruments, which can detect musical instrument intonations according to vibration signals and audio signals so as to facilitate tuning and using musical instruments.

In order to achieve the above purpose, the present disclosure provides the following scheme.

A device for intonation detection and tuning of musical instruments is provided, including a vibration signal acquisition module, an audio signal acquisition module, a vibration signal processing module, an audio signal processing module, a control module and a display module, wherein the vibration signal acquisition module, the audio signal acquisition module, the vibration signal processing module, the audio signal processing module and the display module are connected with the control module;
the vibration signal acquisition module is configured to acquire vibration signals sent by different pipes, strings and keys of a musical instrument;
the vibration signal processing module is configured to analyze and process the acquired vibration signals and convert the acquired vibration signals into data and waveforms, and perform intonation comparison with data and waveforms of standard vibration signals stored in the device;
the audio signal acquisition module is configured to acquire audio signals sent by different pipes, strings and keys of the musical instrument;
the audio signal processing module is configured to analyze and process the acquired audio signals and convert the acquired audio signals into data and waveforms, and perform intonation comparison with data and waveforms of standard audio signals stored in the device.

In some embodiments, the vibration signal acquisition module is a distributed and/or discrete optical fiber vibration sensor; and the audio signal acquisition module is a distributed and/or discrete optical fiber acoustic sensor.

The present disclosure further provides a method for intonation detection and tuning of musical instruments, which is applied to the device for intonation detection and tuning of musical instruments described above, including following steps:
Step 1, acquiring vibration signals sent by different pipes, strings and keys of a musical instrument through a vibration signal acquisition module;
Step 2, acquiring audio signals sent by different pipes, strings and keys of the musical instrument through an audio signal acquisition module;
Step 3, obtaining, by a vibration signal processing module, the acquired vibration signals, comparing the acquired vibration signals with data and waveforms of standard vibration signals stored in the device for identification and analysis, and displaying analysis results on a display module;
Step 4: obtaining, by an audio signal processing module, the acquired audio signals, comparing the acquired audio signals with data and waveforms of standard audio signals stored in the device for identification and analysis, and displaying analysis results on the display module;
Step 5: tuning the musical instrument, including intonation adjustment and timber adjustment, according to analysis results of the vibration signals and analysis results of the audio signals of the musical instrument displayed on the display module, until the analysis results of the vibration signals indicate that the acquired vibration signals are identical to the standard vibration signals and the analysis results of the audio signals indicate that the acquired audio signals are identical to the standard audio signals.

According to the specific embodiment provided by the present disclosure, the present disclosure discloses the following technical effects. The present disclosure provides a device and method for intonation detection and tuning of musical instrument. The device includes a vibration signal acquisition module, an audio signal acquisition module, a vibration signal processing module, an audio signal processing module, a control module and a display module. The method includes: acquiring vibration signals sent by different pipes, strings and keys of a musical instrument through the vibration signal acquisition module; acquiring audio signals sent by different pipes, strings and keys of the musical instrument through the audio signal acquisition module; obtaining, by the vibration signal processing module, the acquired vibration signals, comparing the acquired vibration signals with data and waveforms of standard vibration signals stored in the device for identification and analysis, and displaying analysis results on the display module; obtaining, by the audio signal processing module, the acquired audio signals, comparing the acquired audio signals with data and waveforms of standard audio signals stored in the device for identification and analysis, and displaying analysis results on the display module; performing intonation adjustment and timber adjustment, on the musical instrument, according to analysis results of the vibration signals and analysis results of the audio signals of the musical instrument displayed on the display module, until the analysis results of the vibration signals indicate that the acquired vibration signals are identical to the standard vibration signals and the analysis results of the audio signals indicate that the acquired audio signals are identical to the standard audio signals. The device and the method realize the comparison and identification between the acquired signals and the standard signals based on the vibration signals and the audio signals, display the results on the display module for people to review, and intonations and timbres are regulated according to the results, which is convenient to use.

### BRIEF DESCRIPTION OF THE DRAWINGS

FIG. 1 is a schematic structural diagram of a device for intonation detection and tuning of musical instruments according to an embodiment of the present disclosure.

FIG. 2 is a schematic flow chart of a method for intonation detection and tuning of musical instruments according to an embodiment of the present disclosure.

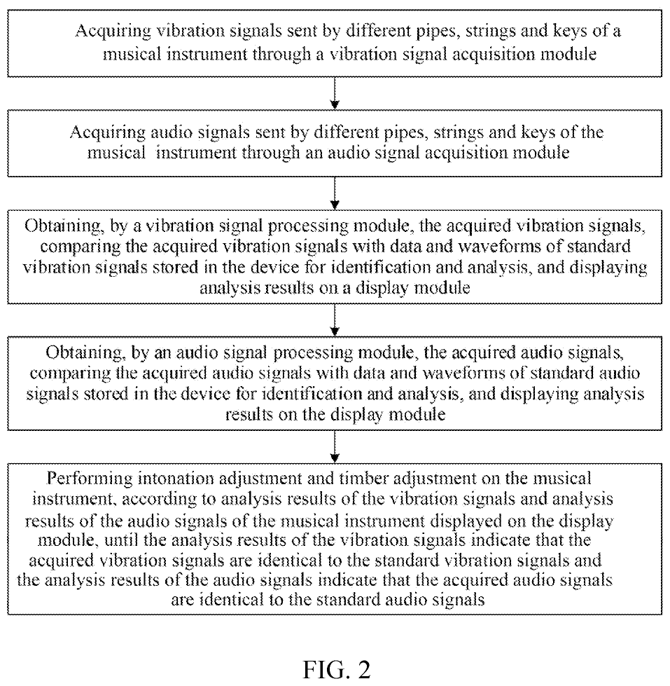

### DETAILED DESCRIPTION OF THE EMBODIMENTS

The purpose of some embodiments in the present disclosure is to provide a device and method for intonation detection and tuning of musical instruments, which can detect musical instrument intonations according to vibration signals and audio signals so as to facilitate tuning the musical instrument, thereby making the device easy to use.

Any sound is generated by vibration, and vibration signals can be acquired by an optical fiber sensing device and converted into digital signals and waveforms. The corresponding relationship between waveform and sound is as follows: the frequency determines the pitch (intonation), the amplitude determines the volume, and the shape of waveforms (rising and falling speed, curves) determines the timbre.

In the present disclosure, first, it is necessary to record audio signals and vibration signals of a standard tone of a musical instrument, for subsequent use.

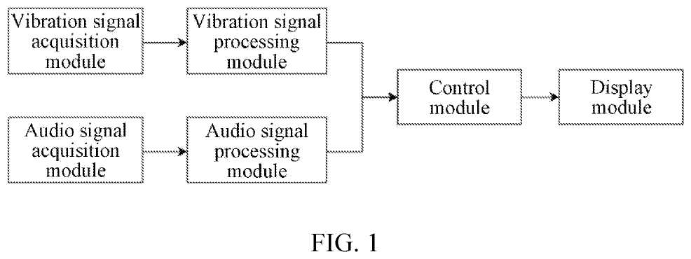

As shown in FIG. 1, a device for intonation detection and tuning of musical instruments provided by the embodiment of the present disclosure includes a vibration signal acquisition module, an audio signal acquisition module, a vibration signal processing module, an audio signal processing module, a control module and a display module, wherein the vibration signal acquisition module, the audio signal acquisition module, the vibration signal processing module, the audio signal processing module and the display module are connected with the control module.

The vibration signal acquisition module is configured to acquire vibration signals sent by different pipes, strings and keys of the musical instrument.

The vibration signal processing module is configured to analyze and process the acquired vibration signals and convert the acquired vibration signals into data and waveforms, and perform intonation comparison with data and waveforms of standard vibration signals stored in the device.

The audio signal acquisition module is configured to acquire audio signals sent by different pipes, strings and keys of the musical instrument.

The audio signal processing module is configured to analyze and process the acquired audio signals and convert the acquired audio signals into data and waveforms, and perform intonation comparison with data and waveforms of standard audio signals stored in the device.

The vibration signal acquisition module is a distributed and/or discrete optical fiber vibration sensor; and the audio signal acquisition module is a distributed and/or discrete optical fiber acoustic sensor.

The present disclosure further provides a method for intonation detection and tuning of musical instruments, which is applied to the device for intonation detection and tuning of musical instruments described above, including the following steps:
Step 1, acquiring vibration signals sent by different pipes, strings and keys of a musical instrument through a vibration signal acquisition module;
Step 2, acquiring audio signals sent by different pipes, strings and keys of the musical instrument through an audio signal acquisition module;
Step 3, obtaining, by a vibration signal processing module, the acquired vibration signals, comparing the acquired vibration signals with data and waveforms of standard vibration signals stored in the device for identification and analysis, and displaying analysis results on a display module;
Step 4: obtaining, by an audio signal processing module, the acquired audio signals, comparing the acquired audio signals with data and waveforms of standard audio signals stored in the device for identification and analysis, and displaying analysis results on the display module;
Step 5: performing intonation adjustment and timber adjustment on the musical instrument, according to analysis results of the vibration signals and analysis results of the audio signals of the musical instrument displayed on the display module, until the analysis results of the vibration signals indicate that the acquired vibration signals are identical to the standard vibration signals and the analysis results of the audio signals indicate that the acquired audio signals are identical to the standard audio signals.

The present disclosure provides a device and method for intonation detection and tuning of musical instruments. The device includes a vibration signal acquisition module, an audio signal acquisition module, a vibration signal processing module, an audio signal processing module, a control module and a display module. The method includes: acquiring vibration signals sent by different pipes, strings and keys of the musical instrument through the vibration signal acquisition module; acquiring audio signals sent by different pipes, strings and keys of the musical instrument through the audio signal acquisition module; obtaining, by the vibration signal processing module, the acquired vibration signals, comparing the acquired vibration signals with data and waveforms of standard vibration signals stored in the device for identification and analysis, and displaying analysis results on the display module; obtaining, by the audio signal processing module, the acquired audio signals, comparing the acquired audio signals with data and waveforms of standard audio signals stored in the device for identification and analysis, and displaying analysis results on the display module; performing intonation adjustment and timber adjustment on the musical instrument, according to analysis results of the vibration signals and analysis results of the audio signals of the musical instrument displayed on the display module, until the analysis results of the vibration signals indicate that the acquired vibration signals are identical to the standard vibration signals and the analysis results of the audio signals indicate that the acquired audio signals are identical to the standard audio signals. The device and the method realize the comparison and identification between the acquired signals and the standard signals based on the vibration signals and the audio signals, display the results on the display module for people to review, and intonations and timbres are regulated according to the results, which is convenient to use.

What is claimed is:

1. A device for intonation detection and tuning of musical instruments, comprising a vibration signal acquisition module, an audio signal acquisition module, a vibration signal processing module, an audio signal processing module, a control module and a display module, wherein the vibration signal acquisition module, the audio signal acquisition module, the vibration signal processing module, the audio signal processing module and the display module are connected with the control module;
the vibration signal acquisition module is configured to acquire vibration signals sent by different pipes, strings and keys of a musical instrument;
the vibration signal processing module is configured to analyze and process the acquired vibration signals and convert the acquired vibration signals into data and waveforms, and perform intonation comparison with data and waveforms of standard vibration signals stored in the device;
the audio signal acquisition module is configured to acquire audio signals sent by different pipes, strings and keys of the musical instrument;
the audio signal processing module is configured to analyze and process the acquired audio signals and convert the acquired audio signals into data and waveforms, and perform intonation comparison with data and waveforms of standard audio signals stored in the device.

2. The device for intonation detection and tuning of musical instruments according to claim 1, wherein the vibration signal acquisition module is a distributed and/or discrete optical fiber vibration sensor; and the audio signal acquisition module is a distributed and/or discrete optical fiber acoustic sensor.

3. A method for intonation detection and tuning of musical instruments, which is applied to the device for intonation detection and tuning of musical instruments according to claim 1, comprising following steps:
Step 1, acquiring vibration signals sent by different pipes, strings and keys of a musical instrument through a vibration signal acquisition module;
Step 2, acquiring audio signals sent by different pipes, strings and keys of the musical instrument through an audio signal acquisition module;
Step 3, obtaining, by a vibration signal processing module, the acquired vibration signals, comparing the acquired vibration signals with data and waveforms of standard vibration signals stored in the device for identification and analysis, and displaying analysis results on a display module;
Step 4, obtaining, by an audio signal processing module, the acquired audio signals, comparing the acquired audio signals with data and waveforms of standard audio signals stored in the device for identification and analysis, and displaying analysis results on the display module;
Step 5, performing intonation adjustment and timber adjustment on the musical instrument, according to analysis results of the vibration signals and analysis results of the audio signals of the musical instrument displayed on the display module, until the analysis results of the vibration signals indicate that the acquired vibration signals are identical to the standard vibration signals and the analysis results of the audio signals indicate that the acquired audio signals are identical to the standard audio signals.

4. The method for intonation detection and tuning of musical instruments according to claim 3, wherein the vibration signal acquisition module is a distributed and/or discrete optical fiber vibration sensor; and the audio signal acquisition module is a distributed and/or discrete optical fiber acoustic sensor.
